(19) United States
(12) Patent Application Publication
(10) Pub. No.: US 2007/0068864 A1
(43) Pub. Date: Mar. 29, 2007

(54) Fold protection for spiral wound filter element

(76) Inventors: Josh de la Cruz, Lake Elsinore, CA (US); Nick Chojnowski, Oceanside, CA (US)

Correspondence Address: SCHWEGMAN, LUNDBERG, WOESSNER & KLUTH, P.A., P.O. BOX 2938, MINNEAPOLIS, MN, 55402, US

(21) Appl. No.: 11/294,642

(22) Filed: Dec. 5, 2005

Related U.S. Application Data
(60) Provisional application No. 60/722,212, filed on Sep. 28, 2005.

(51) Int. Cl. B01D 63/00

(52) U.S. Cl. 210/321.76; 210/321.74; 210/321.83; 210/321.85; 210/321.61

(57) ABSTRACT

A method for preventing osmotic blistering and other defects in the region of a flex line in a spirally-wound sheet filtration element includes applying an effective glue coating as a sealant to the feedstream side of a sheet in regions where a potential for blistering or layer damage exists, such as a fold line. The glue is applied to the inside of the fold, a spacer is positioned at the coated flex line, and the leaf is refolded and wound with other leaves to form a filter unit, such as a UF, NF or RO filter unit. The coating seals surface defects occurring during the fabrication process as well as the surrounding region, and the cured coating strengthens the region so blistering and delamination do not occur.

### CROSS REFERENCE TO RELATED APPLICATIONS

This application claims the benefit under 35 U.S.C. 119 (e) of U.S. Provisional Application No. 60/722,212, filed on Sep. 28, 2005, which is hereby incorporated by reference in its entirety. Reference is also made to commonly owned International Application Serial No. PCT/US2003/019582, filed Jun. 20, 2003, and to U.S. Published Application No. 2005/0121380. The disclosure of each of these applications is incorporated herein by reference.

### FIELD

The invention generally relates to spirally-wound elements made of sheet-like semipermeable membrane material, and more particularly relates to methods of making spirally-wound cross flow membrane elements utilizing membrane filter sheets which are folded upon themselves to create leaves that are then spirally wound about a central porous tube. The leaves are creased at a fold line to form envelopes about a central mesh or spacer material, which serves as the feed path or permeate flow space. One embodiment of the invention will be described for an assembly in which the feed flow proceeds in the interior of the membrane envelope formed by a fold. This may, for example, be a nanofiltration or ultrafiltration membrane as used, for example in the food industry for filtering dairy, sugar or other liquid stream.

### BACKGROUND OF THE INVENTION

Spirally-wound constructions for use in cross flow separation operations are often referred to as elements, cartridges or modules. The spirally-wound elements may be assembled with leaves in the form of folded sheets of polysulfone or polyethersulfone UF membranes, which may optionally carry interfacially created, more selective semipermeable membranes; these leaves are interleaved with sheets of feed passageway-providing material and permeate carrier material. Such elements have traditionally been made by strategically applying adhesive (referred to in the trade as “gluing”) to assemblages or lay-ups of such sheet-like materials and rolling them about a porous tube to create a spirally-wound filtration module.

The earliest semipermeable membranes used for such separation operations were of the asymmetric, cellulose diacetate/triacetate type; however, in the past three decades, these membranes have been supplanted for many separation processes by asymmetric polysulfone or polyethersulfone UF membranes and by composite or thin film membranes wherein a more highly permselective membrane has been coated as a thin layer onto a thicker polysulfone base membrane or porous support. A dense active discriminating layer is often interfacially formed upon a more porous supporting or base layer; the dense layer is often a condensation polymer, such as a polyamide, which provides particularly desirable semipermeable characteristics. Although the more porous supporting layer can be any suitable polymeric material, polysulfones have frequently been used. Such a polysulfone layer having the desired pore size to support the ultrathin interfacial layer is frequently cast upon a thin layer of nonwoven polyester felt backing or scrim material with which the polysulfone layer generally becomes very tightly attached. In the traditional spiral-wound construction, membrane leaves are formed by folding a long sheet having a length approximately twice the final leaf length.

In some separations, polysulfone and polyethersulfone UF membrane, as well as composite sheet materials, have experienced occasional difficulties in the fold area where the fine discriminating membrane and/or thin interfacial membrane is folded upon itself. After use for some time, the fold region of the semipermeable membrane was found to have buckled and cracked, resulting in some leakage of feed solution being fed to the element through these cracks into the permeate carrier. In some cases blisters form in the fold region or along edge regions of the membrane leaves, trapping feed solution or cleaning solution during operation under the surface of the membrane. Even when the cracks do not leak through to the permeate side, they may create an unsanitary spot where bacteria can be harbored, making the membrane unsuitable in food and dairy process plants where products are being made for human consumption.

U.S. Pat. No. 4,842,736 recognized this problem at the fold and proposed an effective solution, teaching the application of flexible sealing material to the felt at the permeate output surface of the membrane material. The sealing material may penetrate and fill the interstices of the porous membrane support in the region of the fold eliminating flow in the region of the fold by blocking the output or downstream, permeate, surface. Materials that were used for this purpose included polyurethane adhesives which were forced into the felt and then cured; or soft melt plastic ribbons that were heated to essentially their melting point and driven into the interstices. A similar solution to this problem of leakage at the fold was described in U.S. Pat. No. 5,147,541, and U.S. Patent Application No. 2004/0099598 further describes treatment along the fold line. U.S. Pat. No. 6,068,771 and U.S. Published Application No. 2003/0034293 disclose using vacuum to draw a polymeric adhesive into the edges of a spiral-wound membrane element.

While the approaches described in these patent documents address leakage due to cracking at a fold, it has been found that membrane leaf-folds which have been so treated to overcome the propensity for leakage through cracks may still experience other deficiencies when operated in environments where they are frequently subjected to harsh cleanings. This is particularly true in food and dairy installations where such spirally-wound elements are often cleaned daily, using cleaning solutions of a caustic or acidic character and/or which may contain high amounts of chlorine. In such regions where the downstream or permeate-output surfaces of such membrane sheet materials are sealed, e.g. in the fold regions, by a process such as one of those just mentioned above, caustic cleaners, for example, can penetrate through potential cracks, become absorbed in portions of the porous backing layers and sometimes create blisters by causing either the polysulfone to split from its substrate backing or the ultrathin layer to split from the polymeric porous base. Such regions also exist along the side and end edges of such membrane material where adhesive is traditionally applied so as to seal the edges of permeate carrier sheets (which provide the pathways adjacent each spirally disposed membrane leaf leading inward to the porous central collecting tube), and these seals will also prevent permeate passing through the active membrane surface in these edge regions from reaching the permeate carrier, as will also be the case in fold regions that have not cracked. It has also been found that liquids or solutions with relatively low osmotic pressure, e.g. DI rinse water, being pumped through the feed carrier windings will diffuse through or be absorbed within the semipermeable membrane in these edge areas, fill the porous region and sometimes cause local separation either of the polysulfone from its substrate or of the interfacial layer from the underlying polymeric base. This occurrence has now come to be referred to as osmotic blistering, and such blisters potentially occur along the glued edges of the membrane sheet lay-ups and in the region of the folds. When the elements are frequently cleaned and then rinsed with low osmotic pressure solutions, such as deionized water or the like, they will occasionally blister. Such blistering is unacceptable in the food and dairy industries, and a solution for this further problem has been sought for a number of years.

### SUMMARY OF THE INVENTION

One embodiment of the invention provides a method for preventing osmotic blistering or damage to the layer structure in spirally-wound elements of semipermeable membrane sheet material, which material includes a microporous selective membrane or a microporous base layer supporting a more discriminating polymeric layer, wherein the membrane material is assembled with adjacent sheet materials to create leaves. It has now been found that the application of a sealant to the upstream or feed input surface of the membrane material at the flexed region, where the sheet has been flexed at a fold line, by adhesive/glue applied as a thin curable coat on the discriminating layer during assembly, provides a successful solution to the troubling problem of potential osmotic blistering, which blistering can potentially occur not only at the fold region, near to flexed but otherwise untreated regions, and also along the longitudinal edges of these membrane material sheets and in the regions of the end seals, in traditionally constructed spirally-wound elements. The sealant used is preferably a thinned glue coat, such as a thinned two-part or catalyzed curable urethane adhesive or sealant. The sealant may be thinned with a membrane-compatible solvent to lower its initial viscosity or enhance it penetrating ability. By membrane-compatible is meant that the sealant/solvent system bonds to the membrane, while the solvent does not impair its physical structure. In one prototype embodiment the sealant was thinned with a major portion of acetone, which is a solvent for the membrane material, without adverse effect on the flexible felt-like backing or downstream membrane layer. The glue or sealant is thinned to a viscosity below several thousand centipoises before applying as a thin seal coat, and the membrane and spacer sheet are preferably set up substantially uncured but in a low tack condition for rolling and assembly of the spiral modules. One embodiment of the invention provides improved spirally-wound liquid separation elements which are inherently resistant to degradation such as osmotic blistering in the fold region or edges and are thus particularly well suited for use in the dairy and food processing industries.

In one aspect, the invention provides a method for preventing osmotic blistering or assembly damage in the fold region of spirally-wound elements of semipermeable membrane sheet material in locations otherwise subject thereto, which method comprises applying a glue coat or sealant to the upstream surface of the membrane sheet material in a band extending along the fold region or regions so that flow therethrough is prevented. The membrane may be creased and then unfolded before application of the glue coat, and is then re-folded about the spacer and tightly wound. The glue coat preferably remains uncured or wet but non-tacky during assembly, and curing occurs substantially after assembly, so that any stresses or surface damage occurring during folding and manipulation and packing of the rolled leaf may be fully coated, relieved and bonded by the sealant. The coating prevents feed liquid from permeating into the membrane in such regions and strengthens the membrane against irregular infiltration conditions and occurrence of osmotic blistering and delamination from the repetitive permeation, pressurization, chemical treatment and other stresses of operation.

In another aspect, the invention provides a method for preventing osmotic blistering in spirally-wound elements of folded semipermeable membrane sheet material, which folded material comprises a polysulfone or polyethersulfone UF membrane. After folding and before leaf assembly, a thinned sealant is applied to the upstream surface of the membrane which is then loosely refolded into a leaf having two rectangular active membrane surface regions bordered by a central sealed surface region.

In a further particular aspect, the invention provides a method for making spirally wound semipermeable membrane elements from semipermeable membrane sheet material, which elements are resistant to osmotic blistering, which method comprises the steps of providing an extended length of the membrane sheet material, sufficient to provide a plurality of folded leaves for spiral winding, which material includes a supporting microporous base layer and a thin semipermeable discriminating layer having an upstream surface and a downstream surface, with its downstream surface being in contact with said base layer, applying a sealant pattern to the upstream surface of the discriminating layer along its longitudinal edges and at spaced apart locations along said extended length where each of said plurality of leaves would be folded and where they would end, which sealant is effective to prevent liquid from permeating through the discriminating layer in such locations, cutting said extended length into a plurality of panels for folding to create said leaves, wherein the sealant is compatible with a base layer providing physical support for the discriminating layer and forms a continuous impermeable coating reinforcing and sealing said fold regions to prevent leakage through or delamination/blistering of the discriminating layer occur during operation.

### BRIEF DESCRIPTION OF THE DRAWINGS

FIG. 1 shows a cross sectional view of a membrane element, in accordance with one embodiment.

FIG. 2 shows a detailed view of a fold region of a membrane sheet, in accordance with one embodiment.

FIG. 3 shows a top view of a membrane sheet, in accordance with one embodiment.

FIG. 4 shows a perspective view of a membrane sheet during assembly, in accordance with one embodiment.

### DETAILED DESCRIPTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that structural changes may be made without departing from the scope of the present invention. Therefore, the following detailed description is not to be taken in a limiting sense, and the scope of the present invention is defined by the appended claims and their equivalents.

It is often the case that spirally-wound semipermeable membrane elements may be subjected to relatively harsh cleaning conditions as often as twice a day in the dairy and some food processing industries to assure cleanliness and sanitation. Consistent with maintaining such standards, these installations, including the separation elements, are frequently inspected by the FDA inspectors who are alert to potential deficiencies that might be created in the elements, such as osmotic blistering of membranes. Detection of osmotic blistering will likely cause the certification of the product to be lowered to one suitable for animal feed only and, as such, needs to be avoided. As a result, the desirability of alleviating such potential problems became evident at an early date, and the present invention represents a surprisingly straightforward solution to this problem.

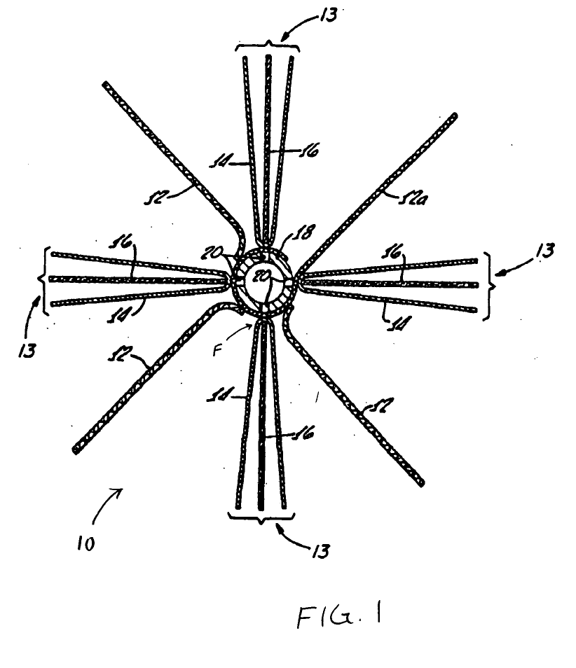

FIG. 1 shows a cross-sectional view of a membrane element 10 as it would be laid up for winding in a spiral-wound module assembly. Spirally-wound cross flow membrane element 10 includes a wrapping of multiple groups of permeate carrier sheet material 12 and leaves 13 that constitute individual sandwiches wherein semipermeable membrane material sheet 14 is folded about a feed carrier sheet 16; the wrapping is around a central tube 18 which serves as a permeate collection pipe. The sidewall of the central tube 18 can either be porous or provided with defined openings 20 through which the liquid can pass that has permeated through the semipermeable membranes and traveled inward in the permeate carrier sheets 12 to the tube, from which it is discharged via one or both ends as desired. As well known in this art of cross flow filtration, the feed liquid being treated enters one end of the spirally-wound element and flows axially therethrough, with a concentrate or brine exiting the opposite end. In its travel through the element from end to end, water or another permeating component will be separated and pass through the upstream permeselective surface of the membrane material and then through the felt or scrim layer upon which the membrane was cast until reaching the permeate carrier sheet 12; the remainder of the liquid feed flows axially toward the discharge end, growing continuously more concentrated as permeation occurs through the upstream surface area of the semipermeable membrane. Once the permeating liquid component reaches the permeate carrier sheeting 12, it then flows spirally inward therewithin until it reaches the porous central tube 18.

As depicted in FIG. 1, an element is assembled from a plurality of leaves 13 of folded sheets of semipermeable membrane material 14 which each sandwich a sheet of feed carrier material 16; the discriminating or permeselective semipermeable surface faces inward, lying adjacent the feed carrier sheet. Four such leaves 13 are schematically depicted in FIG. 1 although it should be understood that a larger or smaller number of leaves could be employed depending upon the overall characteristics desired for the element. As depicted, all of the leaves are of the same length and have traditionally been cut from an extended length or roll of raw membrane material that has been fabricated with a desired width, e.g. about 40 inches. Typically, a roll of such semipermeable membrane material might be 2,000 yards long, and individual panels that are cut therefrom for leaves will vary from about 40 inches to 100 inches in length (which in its folded-over configuration would constitute a leaf from 20 to 50 inches long). These cut panels of semipermeable membrane material are then folded about individual sheets 16 of feed carrier of the same width, which are similarly cut to appropriate lengths of about 20 to 50 inches. The feed carrier may be highly porous, woven, screen-like material such as those sold under the trade name Vexar by Conwed Plastics.

As depicted in FIG. 1 the sandwiches 13 are interleaved between a similar number of individual leaves of permeate carrier 12, e.g. Tricot polyester woven or knitted, rigidized material, one of which may be wrapped peripherally around the porous central tube 18. Once an assemblage is arranged as shown in FIG. 1 where four sandwiches 13 and four leaves of permeate carrier material 12 are illustrated, the assemblage is ready to be wrapped tightly about the central tube 18 as by rotating the tube, as well known in this art.

A more detailed discussion of various assembly details may be found in the aforementioned U.S. Pat. No. 4,842,736, as well as in US Published Patent Application 2005/0121380, both of which are incorporated herein by reference, and other generally available publications.

As relevant to the present invention, the region of the membrane 14 which is creased or folded and shown adjacent the central pipe 18 in FIG. 1 is particularly susceptible to damage or degradation, and this region F is designated as the “fold region” herein. The term “fold line” is applied to the line at which folding occurs. While FIG. 1 is largely schematic and shows a gently-curved or U-shape bend, in practice the fold region is thickened, and the need to fit a large area of filter membrane while accommodating sufficient inter-membrane space for feed and permeate flow, requires in practice that the fold region be tightly crimped or creased. The layered structure of the membrane at the fold line is therefore subject to extreme stresses and forces of buckling or delamination due to pressure and the differential strains of folding. The fold region F may also suffer abrasion or mechanical damage to the thin discriminating (fine pore) layer inside the fold from the ends of spacer 16. These, and the chemical duress of cleaning as well as the repetitive pressure cycles of operation may give rise to bubble and blister formation at any leakage/defect/blocked loci. To some extent, adhesive sealant lines along lateral edges may also suffer such problems over time. Typical physical structure involved in the edge seals, O-ring seals, and housings of these filtration assemblies may be found in the above-reference patent documents and are known to those skilled in the art.

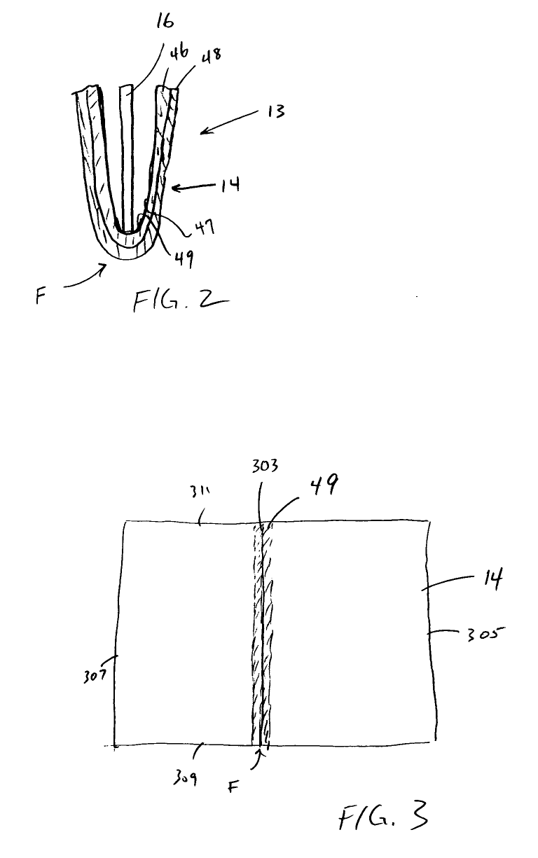

FIG. 2 shows a detailed view of a fold region of membrane material sheet 14 in accordance with one embodiment. The membrane material sheet 14 may include any of the known semipermeable membrane materials currently used for cross flow filtration in spirally wound cartridges. These include UF membranes made of polysulfone or polyethersulfone, other asymmetric membranes such as cellulose acetate and cellulose triacetate, and thin film composite membranes of the various types, e.g. RO membranes, ultrafiltration and nanofiltration membranes. In some embodiments, the invention is believed to have particular application to such thin film composite membranes, whereas asymmetric membranes have the potential for blistering at the interface between the scrim or felt backing material upon which the casting occurred. Composite membranes have not only this potential but also the potential for blistering at the interface between the porous polymeric base and the more selective thin film which, as previously indicated, may be interfacially formed thereon as by a condensation reaction.

In some embodiments, semipermeable membrane material sheet 14 may be fabricated, for example, by first casting a polyethersulfone ultrafiltration membrane 46 on a AWA polyester felt scrim material 48 and then employing it as a microporous base and creating an ultrathin film reverse-osmosis or nanofiltration membrane discriminating layer 47 atop this ultrafiltration base layer via an interfacial condensation reaction, as well known in the art. For example, the surface of the ultrafiltration base 46 may first be treated with an aqueous amine solution; subsequently, a reactive component such as a di- or triacylchloride in an organic solvent is applied to effect the condensation reaction, which results in the ultrathin film membrane, all as well known in this art. For example, polyamide thin film composite membranes, as taught in U.S. Pat. No. 4,277,344 to Cadotte, have been state-of-the-art reverse osmosis membranes for over a decade. Discriminating layer 47 has an upstream surface and a downstream surface with its downstream surface being in surface-to-surface contact with base layer 46.

Membrane material 14 includes a sealant film layer 49 along the upstream surface of the membrane 14 across regions that are proximate to fold region F to prevent liquid from permeating into the membrane. As will be discussed further, in some embodiments, sealant film layer 14 is about 0.010″ or less in thickness. In other examples, it is about 0.003″ or less. In some embodiments, it is between about 0.001″ thick and about 0.003″ thick. In this example, the base layer 46/48 does not include a sealant on the downstream side in fold region F. Accordingly, sealant layer 49 prevents liquid from flowing into membrane 14 from the upstream side, but permeate from the downstream side is not blocked from membrane sheet 14. It has been found that this prevents the blistering and other fold region damage of past designs. The coating prevents feed liquid from permeating into the membrane in such regions and strengthens the membrane against irregular infiltration conditions and occurrence of osmotic blistering and delamination from the repetitive permeation, pressurization, chemical treatment and other stresses of operation.

A method to apply the glue coat sealant film layer 49 to the upstream surface of the membrane sheet will now be described. Prior to application, the sealant of film layer 49 is preferably a thinned glue coat, such as a thinned two-part or catalyzed curable urethane adhesive or sealant. The sealant may be thinned with a membrane-compatible solvent to lower its initial viscosity or enhance it penetrating ability. By membrane-compatible is meant that the sealant/solvent system bonds to the membrane, while the solvent does not impair its physical structure. In one embodiment the sealant can be thinned with a major portion of acetone, which is a solvent for the membrane material, without adverse effect on the flexible felt-like backing or downstream membrane layer. In one embodiment, the glue or sealant is thinned to a viscosity below several thousand centipoises before applying as a thin seal coat 49.

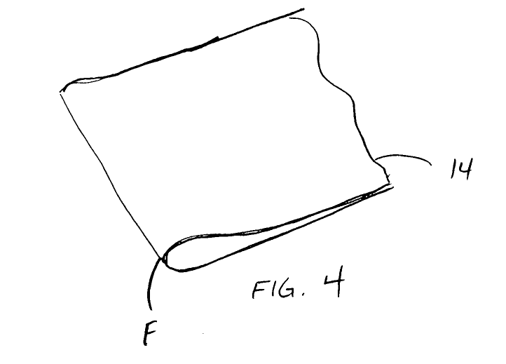

Referring to FIG. 3, which shows a top view of a membrane sheet 14, in one embodiment, a curable adhesive, such as described above, can be used, with a usable working time of about half an hour. For example, in one prototype assembly, the adhesive, which had a honey-like viscosity, was thinned with acetone to a lesser viscosity to make it suitable for coating with typical painting utensils, e.g., wipe-on sponges. Among the adhesives usable are Loctite USO135 and an Epmar adhesive UR3543, for example.

The starting adhesive was relatively viscous, over 4,000 centipoise, and in order to achieve a sufficiently thin and flowable material, the two part curable polyurethane was thinned with solvent (20% urethane, 80% acetone).

The membrane sheet 14 was laid out and cut to the desired length, approximately twice the intended length of the final leaf, and was folded over a feed spacer 16 and creased along its center line 303. The membrane was then unfolded and the feed spacer pull back to expose the fold region F. A protective film could be placed over the feed spacer at this time to protect from adhesive spillage in the next stage. If such a protective sheet is used, it is removed immediately after the glue coating step.

Using a sponge-brush, the thinned adhesive is then applied as a glue coat film layer 49 along the fold line 303 and to a band extending an inch or two to each side of the line within fold region F. The coating was applied in a coating one to three mils thick, e.g., about the thickness of a layer of floor varnish. In other examples, the coating can be about 10 mils thick or less. Referring now also to FIG. 4, the membrane sheet 14 is then loosely refolded, so that one end of the sheet is brought over to lie above the other. The loosely folded over sheet is then moved by sliding along the work surface to a membrane assembly area. When folded over, the membrane is not tightly folded or creased, so as to avoid mechanical shifting, adhesion, premature drying and mechanical stress or other possible damage from excessive handling. A stiff sheet of card stock can be placed between each successive membrane moved to the end to allow further membranes to be readily stacked or “shingled” and subsequently handled and moved about. The glue coat film layer 49 preferably remains uncured or wet but non-tacky or non-sticky during assembly, and curing occurs substantially after assembly, so that any stresses or surface damage occurring during folding and manipulation and packing of the rolled leaf may be fully coated, relieved and bonded by the sealant.

Following completion of the cut and lay up operation, the stack may be inverted by physically moving each membrane from the top down onto an adjacent stack area. This reverses their order, placing the oldest (earliest-coated) membranes at the top of the stack for earliest assembly into complete spiral assemblies. Applicant has found that for a hand-assembly operation, a cure time of several hours to half a day provides a reasonable working interval for coating, lay up and assembly without risk of premature stiffening of the coat or adhesive complications. It is preferred that the glue coat attain a non-tacky state relatively quickly so as to avoid problems during the vulnerable lay up and assembly handling period. Accordingly, the membrane 14 and spacer sheet 16 are preferably set up substantially uncured but in a low tack, non-sticky condition for rolling and assembly of the spiral modules. This means the spacer is positioned within the fold region to form a leaf when the glue coat is uncured but has a hardened outer surface. Then after assembling the leaf in a spiral wound module, the glue coat cures when assembled with the membrane sheet sealed and strengthened in the fold region against blistering and cracking in use.

It will be appreciated that the coating treatment described above may be applied to fortify or protect other vulnerable regions of the membrane against degradation and blistering during extended use. Applicants believe that regions of membrane subject to mechanical stresses as a result of the assembly conditions of physical structure—e.g., as a result of pinching, sealing, securing or positioning structures of the spiral module construction, or regions subject to concentrated or long-duration chemical extremes such as edge regions where strong cleaners such a chlorine or caustic may not be readily or fully flushed during cleaning cycles, or where sharp pressure gradients may arise locally, may all be prone to such damage and may benefit by use of the present invention. For example, one or more of edges 305, 307, 309, 311 can also be coated.

After lay-up, the folded glue-coat protected membrane fabrication/rolling of the spirally-wound element may be done in the traditional manner. As well known in this art (see U.S. Pat. No. 4,482,736), bands of adhesive are applied along the side edges and the end edges of each of the leaves of permeate carrier in sufficient quantity so as to totally saturate the thickness of the permeate carrier. As a result, this adhesive seals the three edges thereof and also penetrates into and seals the usually thinner scrim layers at the outer surfaces of each of the several membrane leaves 13, which are interleaved between the radially extending leaves of permeate carrier 12 as depicted in FIG. 1.

When winding takes place, the crease of the folded membrane 14 with its sandwiched feed carrier sheet 16 will be in the nip between the leaves 12 of permeate carrier, with the crease being located near initially wrapped central tube 18. As the tube is rotated during this fabrication, a spiral winding is formed, and the porous permeate carrier 12 becomes secured along both of its surfaces to the adjacent scrim layers of the folded semipermeable membrane material 14 via the adhesive bands. Once the winding of the assemblage is complete, a further band of such adhesive that is laid down along the end edge of each permeate carrier sheet 12 thus effecting the complete sealing of three edges of each permeate carrier sheet so the only exit therefrom is at the spirally inward edge adjacent the porous tube 18. Of course, the only entry to the permeate sheets is via the discriminating membrane which faces the feed carrier sheet 16.

Although the invention has been described with regard to the preferred embodiments which constitute the best mode presently known to the inventor for carrying out this invention, it should be understood that various changes and modifications as would be obvious to those having the ordinary skill in the art may be made without departing from the scope of the invention which is set forth in the claims appended hereto. For example, although the description of the cross flow elements are described as using Tricot polyester woven material as a permeate carrier and using a Vexar spacer material as a feed carrier, it should be understood that any of the multitude of materials that have been used for this purpose over the past two decades for spirally-wound cross flow membrane elements may be instead employed. Likewise, although polyamide thin film composite membranes and polysulfone and polyethersulfone UF membranes were mentioned in detail as the membrane materials, it should be understood that other such selective polymeric films, including those interfacially formed on the surface of the microporous layer, which have been developed for nanofiltration and reverse-osmosis purposes, can alternatively be employed. Likewise, although the preferred microporous base layer is one which would also function as a polysulfone or a polyethersulfone UF membrane, other such microporous materials, such as have been developed for microporous operations, can alternatively be employed. Generally, elements employing ultrafiltration, RO, or nanofiltration membrane materials can benefit from the invention. The disclosures of all U.S. patents hereinbefore mentioned are expressly incorporated herein by reference.

It is understood that the above description is intended to be illustrative, and not restrictive. Many other embodiments will be apparent to those of skill in the art upon reviewing the above description. The scope of the invention should, therefore, be determined with reference to the appended claims, along with the full scope of equivalents to which such claims are entitled.

What is claimed is:

1. A method for preventing osmotic blistering or membrane damage in a spirally-wound semipermeable membrane sheet material having an upstream or feed side surface, a downstream or permeate side surface and a fold region, the method comprising:
applying a curable glue coat to the upstream surface of the membrane sheet in a region about a fold line;
positioning a spacer within the fold region to form a leaf when the glue coat is uncured but has a hardened outer surface; and
assembling the leaf in a spiral wound module such that the glue coat cures when assembled with the membrane sheet sealed and strengthened in said fold region against blistering and cracking in use.

2. The method of claim 1, including folding, creasing, and unfolding the membrane sheet at the fold line before applying the curable glue coat.

3. The method of claim 1, wherein the curable glue coat includes a thickness of about 0.010″ or less.

4. The method of claim 1, wherein the curable glue coat includes a thickness of between about 0.001″ and about 0.003″.

5. The method of claim 1 wherein said membrane sheet includes a supporting microporous base layer and a semipermeable discriminating layer, wherein the semipermeable discriminating layer is the upstream layer and has its downstream surface supported upon and in contact with said base layer, and wherein said base layer does not include a sealant on the downstream side in said fold region.

6. The method of claim 5 wherein said curable glue coat is applied to the upstream surface of the discriminating layer in a pattern which includes the region of the fold and along both longitudinal edge surface regions thereof where the base layer will be adhesively attached to an associated permeate-carrying sheet in forming a spiral-wound element.

7. The method of claim 6 wherein said curable glue coat is further applied to the upstream surface of said discriminating layer along an end region thereof.

8. The method of claim 1 wherein the curable glue coat is a curable polymeric adhesive having a viscosity before curing of under 4,000 centipoise.

9. The method of claim 8 wherein the curable polymeric adhesive is thinned to a viscosity under 3,000 centipoise with a solvent to provide a defect penetrating curable film with a wet working time of about ten minutes to ten hours.

10. The method of claim 1 wherein the membrane sheet includes a polymeric material and the curable glue coat includes at least some solvent for said polymeric membrane material and forms a dense impermeable coating thereon.

11. The method of claim 10 wherein the membrane sheet includes a base layer having a fibrous flexible microstructure and the solvent does not degrade flexibility of the microstructure.

12. The method of claim 1 wherein the glue coat is thinned with acetone or compatible solvent to seal the upstream surface without degrading a flexible support layer forming a downstream side of the membrane sheet.

13. The method of claim 1 wherein the upstream surface is an RO, UF or NF thin discriminating layer supported by a base layer.

14. A spirally wound liquid separation element which comprises:
a plurality of leaves of sheet-like semipermeable membrane material which include a supporting microporous base layer and a semipermeable discriminating layer, which has an upstream surface and a downstream surface with its downstream surface being in surface-to-surface contact with said base layer, each of said leaves being folded upon itself to define a fold line;
a porous feed material sheet sandwiched between facing upstream surfaces of each said folded leaf; and
porous permeate carrier material associated with and flanking each of said folded leaves;
wherein said membrane material includes a sealant film layer along the upstream surface of the membrane across regions that are proximate to the fold line to prevent liquid from permeating into the membrane from the upstream side.

15. The element of claim 14, the sealant film layer being about 0.010″ or less.

16. The element of claim 14, wherein said membrane sheet includes a supporting microporous base layer and a semipermeable discriminating layer, wherein the semipermeable discriminating layer is the upstream layer and has its downstream surface supported upon and in contact with said base layer, and wherein said base layer does not include a sealant on the downstream side in said fold region.

17. The element of claim 14, wherein the sealant film layer is between about 0.001″ thick and about 0.003″ thick.
